(19) United States
(12) Patent Application Publication
(10) Pub. No.: US 2011/0033758 A1
(43) Pub. Date: Feb. 10, 2011

(54) POROUS FLOW FIELD PLATE FOR MOISTURE DISTRIBUTION CONTROL IN A FUEL CELL

(76) Inventor: Robert Mason Darling, South Windsor, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/936,590

(22) PCT Filed: Apr. 17, 2008
(86) PCT No.: PCT/US08/60554

§ 371 Date: Oct. 6, 2010

(51) Int. Cl. H01M 8/06

(52) U.S. Cl. 429/414

(57) ABSTRACT

A flow field plate for use in a fuel cell includes a porous, wettable plate body. A plurality of flow channels are arranged on the body such that an inlet portion of a first flow channel is adjacent an outlet portion of a second flow channel. Moisture from a fluid in the outlet portion of the second flow channel can move through the body of the porous, wettable plate from the outlet portion of the second flow channel toward the adjacent inlet portion of the first flow channel.

### BACKGROUND

Fuel cells utilize an electrochemical reaction for producing electrical power. Reactant flow field plates include channels for directing reactants such as fuel and air within the fuel cell. The flow field plates include channels for directing the reactants such that the reactants are available at catalyst layers of a membrane assembly in the fuel cell.

Conventional flow plates include straight channels across the flow plate. A plurality of such channels are arranged parallel to each other.

One challenge associated with maintaining good fuel cell performance is having sufficient humidification of the air and fuel carried within the channels of the flow plates. One technique of humidifying the reactants within a fuel cell includes using a porous water transport plate to circulate water within the fuel cell assembly. Drawbacks of porous plates include an increase in size as they are thicker than metal, limited temperature range and they may ingest reactant gas. A drawback associated with conventional humidification techniques is that they require an external water loop. Adequate humidification is more difficult to accomplish when solid (e.g., non-porous) flow field plates are used.

It would be desirable to be able to realize adequate humidification without the risk of coolant being mixed with a gas stream and without requiring an external humidification circuit.

### SUMMARY

An exemplary flow field plate for use in a fuel cell includes a porous, wettable plate body. A plurality of flow channels are arranged on the body such that an inlet portion of a first flow channel is adjacent an outlet portion of a second flow channel. Moisture from a fluid in the outlet portion of the second flow channel can move through the body of the porous, wettable plate from the outlet portion of the second flow channel toward the adjacent inlet portion of the first flow channel.

An exemplary method of managing moisture distribution in a fuel cell assembly includes supplying a dry fluid into a first flow channel inlet portion. A relatively more moist fluid is directed through a second flow channel outlet portion that is adjacent the first flow channel inlet portion. Moisture from the second flow channel outlet portion is allowed to move through a porous, wettable plate body from the second flow channel outlet portion toward the first channel inlet portion.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates an example flow field plate designed according to an embodiment of this invention.

FIG. 2 schematically illustrates an example flow field plate designed consistent with the embodiment of FIG. 1.

### DETAILED DESCRIPTION

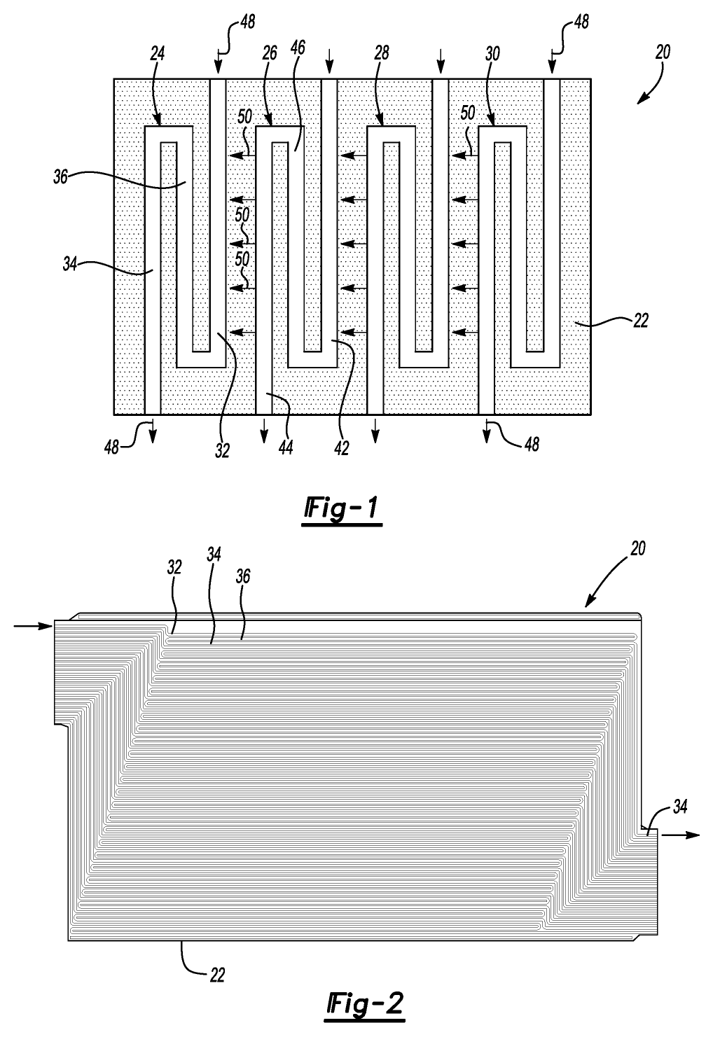

FIGS. 1 and 2 schematically shows an example flow field plate 20 used in a fuel cell. A plurality of flow channels are provided on a body 22 of the flow field plate 20. In this example, the body 22 is porous and wettable.

In the illustrated examples, a plurality of flow channels 24, 26, 28 and 30 are provided on the plate body 22. A first flow channel 24 has an inlet portion 32 and an outlet portion 34. The first flow channel 24 also includes an intermediate portion 36 between the inlet portion 32 and the outlet portion 34.

Similarly, a second flow channel 26 has an inlet portion 42, an outlet portion 44 and an intermediate portion 46.

As can be appreciated from FIG. 1, fluid flowing as schematically shown by the arrows 48 follows a serpentine path across the plate body 22. Fluid flowing within the inlet portions of the flow paths is at a higher pressure than fluid flowing through the outlet portions. Fluid introduced to the inlet portions (e.g., fuel gas or air), is dryer than the fluid flowing through the outlet portions. The normal operation of a fuel cell typically results in more moisture within the fluid closer to the outlet of a flow channel compared to the inlet for known reasons. The moisture in the outlet portion can be at least partially condensed and removed from the gas flow out of the outlet portion.

The inlet portion 32 of the first flow channel 24 is adjacent the outlet portion 44 of the second flow channel 26. This arrangement allows for moisture within the fluid in the outlet portion 44 of the second flow channel 26 (e.g., condensed moisture) to move across the body 22 of the plate 20 in a direction from the outlet portion 44 to the inlet portion 32. Moisture movement of this type is schematically shown by the arrows 50 in FIG. 1. The relatively higher capillary pressure within the inlet portions will tend to wick any condensed moisture (e.g., water) from the adjacent outlet portion of the next flow channel toward the inlet portion through the corresponding portion of the plate body 22. Arranging the flow channels as shown in FIGS. 1 and 2 and using a porous, wettable plate body 22 allows for moisture distribution along the plate 20 to provide humidification to air or another fluid introduced into the inlet portions of the flow channels.

One feature of this arrangement is that it does not require an external loop to provide humidification. Additionally, there is no danger of the reactant gas streams mixing in the coolant passages.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-11. (canceled)

12. A flow field plate for use in a fuel cell, comprising
a porous, wettable plate body having a plurality of flow channels arranged on the body,
each of the channels having an inlet near one edge of the plate and an outlet near an opposite edge of the plate,
at least some of the channels having
an inlet portion between the inlet and an intermediate portion, the inlet portion including a first section beginning at the inlet, a second section transverse to the first section and a third section transverse to the second;
the intermediate portion being aligned with and next to the inlet portion third section; and
an outlet portion between the intermediate portion and the outlet, the outlet portion including a first section aligned with and next to the intermediate portion, a second section transverse to the first section of the outlet portion and a third section transverse to the second section of the outlet portion,
the at least some of the channels being arranged on the plate body such that the first section of the outlet portion of one of the at least some channels is aligned with and next to the third section of the inlet portion of another one of the at least some channels such that moisture from a fluid in the first section of the outlet portion of the one channel can move through the body from the first section of the outlet portion of the one channel toward the adjacent third section of the inlet portion of the another one of the channels.

13. The flow field plate of claim 12, wherein the flow channel sections follow a continuous, serpentine path along the body from the inlet to the outlet.

14. The flow field plate of claim 2, wherein the third section of the inlet portion directs fluid in a first direction along the body, the first section of the outlet portion directs fluid in the first direction and the intermediate portion directs fluid in a second, opposite direction along the body.

15. The flow field plate of claim 12, wherein the third sections of the inlet portions, the intermediate portions and the first sections of the outlet portions occupy a substantial surface area of the plate body and the first sections of the inlet portions and the third sections of the outlet portions occupy a substantially smaller portion of the surface area of the plate body.

16. The flow field plate of claim 12, wherein each of the second sections of the inlet portions has a length that is different than all others of the second sections of the inlet portions.

17. The flow field plate of claim 16, wherein each of the first sections of the inlet portions has a length that is different than all others of the first sections of the inlet portions.

18. The flow field plate of claim 16, wherein each of the third sections of the inlet portions has a same length as all others of the third sections of the inlet portions, all of the intermediate portions have a same length and each of the first sections of the outlet portions has a same length as all others of the first sections of the outlet portions.

19. The flow field plate of claim 12, wherein each of the second sections of the outlet portions has a length that is different than all others of the second sections of the outlet portions.

20. The flow field plate of claim 19, wherein each of the third sections of the outlet portions has a length that is different than all others of the third sections of the outlet portions.

21. The flow field plate of claim 20, wherein each of the third sections of the inlet portions has a same length as all others of the third sections of the inlet portions, all of the intermediate portions have a same length and each of the first sections of the outlet portions has a same length as all others of the first sections of the outlet portions.

22. The flow field plate of claim 12, wherein the fluid flowing through the inlet portions is at a higher pressure than the fluid flowing through the outlet portions.

23. The flow field plate of claim 12, wherein the fluid in the inlet portion comprises dry air and the fluid in the outlet portion comprises moist air and liquid water.
